(19) United States
(12) Patent Application Publication
(10) Pub. No.: US 2019/0347765 A1
(43) Pub. Date: Nov. 14, 2019

(54) METHOD OF CREATING AN IMAGE CHAIN

(71) Applicant: Siemens Healthcare GmbH, Erlangen (DE)

(72) Inventors: Andreas Maier, Erlangen (DE); Philipp Bernhardt, Forchheim (DE)

(21) Appl. No.: 16/404,975

(22) Filed: May 7, 2019

(30) Foreign Application Priority Data
May 11, 2018 (EP) 18171788.5

(51) Int. Cl. G06T 3/40; G06T 5/30; G06N 3/08

(52) U.S. Cl. CPC G06T 3/4038; G06T 5/30; G06T 2207/10116; G06T 2207/20084; G06T 2207/10016; G06N 3/084

(57) ABSTRACT

A method is provided for creating an image chain, the method including identifying image processing functions required by the image chain, replacing each image processing function by a corresponding neural network, determining a sequence of execution of instances of the neural networks for the image chain, and applying backpropagation through the neural networks of the image chain.

### CROSS REFERENCE TO RELATED APPLICATIONS

This application claims the benefit of EP18171788.5, filed on May 11, 2018, which is hereby incorporated by reference in its entirety

### FIELD

Embodiments describe a method of creating an image chain.

### BACKGROUND

In imaging techniques such as X-ray imaging, initial or “raw” data may be subject to several processing steps to obtain an image that may be presented to a user, for example for diagnostic purposes. The initial processing steps may be referred to collectively as “image pre-processing”, since the steps are necessary to obtain an image that may be viewed by a user. A sequence of image processing steps may be performed. The sequence or chain of steps or “method blocks” may be referred to as the “imaging chain” or “image chain”. An image chain may include several method blocks, for example Laplace pyramid decomposition, shrinkage, and re-composition.

Each method block may involve several linear and/or non-linear operations or functions. Examples of functions are filtering, filtering, padding, edge detection, edge preservation, convolution, wavelet shrinkage, etc. An image chain may include a specific sequence of imaging method blocks, each with a specific sequence of image processing functions.

To operate correctly, an image processing function may be configured or set up using appropriate parameters. Many parameters may be necessary to configure a single processing step, for example cut-off frequencies for a Laplace pyramid, standard deviation of Gaussian or bilateral filters, ε (epsilon) for parameter shrinkage, etc. The results of one image processing function may affect an image processing function further downstream in the image chain, and may also need to be taken into account when choosing the input parameter set for the image processing functions of a method block. However, it may be very difficult to determine the extent to which a specific parameter will affect the overall image quality.

For these reasons, it is difficult and time-consuming to identify a satisfactory input parameter set for each method block of an image chain. A customer of an imaging system may expect this step to be taken care of by the manufacturer. However, it is difficult for the manufacturer of an imaging system to configure the image chain in such a way that all customers will be equally satisfied with the results. One possible approach may be to allow the customer to take care of parameter selection to some extent, for example using a multiple-choice approach, but this might require the customer to obtain an in-depth understanding of the entire image chain. It may be expected that such an additional level of effort would be unacceptable to most customers.

### SUMMARY AND DESCRIPTION

The scope of the present invention is defined solely by the appended claims and is not affected to any degree by the statements within this summary. The present embodiments may obviate one or more of the drawbacks or limitations in the related art.

Embodiments provide an image processing method.

In an embodiment, a method of creating an image chain includes the steps of identifying a set of image processing functions required by the image chain; replacing each image processing function by a corresponding neural network; determining a sequence of execution of the neural networks; and applying backpropagation to adjust the performance of the neural networks.

Instead of a sequence of functions that each operates independently and separately, the performance or behavior of a neural network in the image chain is adjusted according to the other neural networks. The mutual adjustment results in significantly fewer parameters required for the image chain. A conventional type of image chain may require several hundred parameters to be specified for a sequence of independent and separate image processing functions.

In an embodiment, the image processing method includes the steps of creating such an image chain, and passing an image through the image chain to obtain an image processing result. The image quality obtained by the image processing method compares favorably with the image quality obtained by a conventional image chain, but may be achieved with significantly less effort.

In an embodiment, the imaging system includes an input for obtaining an image generated by an imaging device; a processor realized to carry out the image processing method; and a display unit for presenting the image processing results to a user.

Units or modules of the imaging system mentioned above, for example, the image chain, may be completely or partially realized as software modules running on a processor. A realization largely in the form of software modules may include have the advantage that an image processing application already installed on an existing imaging system may be updated, with relatively little effort, to implement an image chain in the image processing method. Embodiments also provide a computer program product with a computer program that is directly loadable into the memory of a control unit of an imaging system, and that includes program units to perform the steps of the method when the program is executed by the control unit. In addition to the computer program, such a computer program product may also include further parts such as documentation and/or additional components, also hardware components such as a hardware key (dongle etc.) to facilitate access to the software. A computer readable medium such as a memory stick, a hard-disk or other transportable or permanently-installed carrier may serve to transport and/or to store the executable parts of the computer program product so that the parts may be read from a processor unit of an imaging system. A processor unit may include one or more microprocessors or their equivalents.

As indicated above, the terms “imaging chain” and “image chain” are synonymous and may be used interchangeably in the following. The method may be used to create an image chain for any kind of image processing task. The image chain may be used in a medical imaging system. The imaging device may be used to generate the initial or raw data for an X-ray imaging device.

An image chain may be regarded as a sequence of basic image processing blocks or “method blocks”. Each method block serves to complete a certain image processing task such as Laplace decomposition, bilateral filtering, Gaussian filtering, shrinkage, Fourier transformation, or median/quantile filtering. In a conventional image chain, each method block may perform a task using a sequence of image processing functions, and the same image processing function may be used by one or more method blocks. A conventional image chain may therefore be associated with a pool or set of image processing functions.

In an embodiment, the step of identifying the set of image processing functions includes identifying method blocks of the image chain and identifying any image processing functions implemented in each method block of the image chain.

An image processing function may be a linear operation such as a Gauss filter operation, a Vesselness filter operation to enhance threadlike structures, a wavelet shrinkage operation to perform smoothing or de-noising, etc. A linear operation may be modelled in a mathematically exact manner by a neural network.

An image processing function may be a non-linear operation such as an erosion filter operation, a dilatation filter operation, a median filter operation, etc. A sub-gradient descent technique may be used to identify a neural network for such an image processing function.

Not all non-linear functions may be represented in a mathematically exact manner by a neural network. In an embodiment, the method of creating an image chain includes a step of applying a universal approximation theorem to obtain a neural network for the non-linear operation.

The set of image processing functions or operations required to construct the conventional image chain is replaced by an equivalent set of neural networks.

As indicted above, significantly fewer parameters are required to configure the image chain, compared to a conventional image chain. In an embodiment, the method includes a step of identifying an initial parameter set for the neural networks of the image chain. The initial parameter set may include a set of parameters chosen as an “intelligent guess”, without any significant effort to choose the set of parameters with the aim of obtaining an optimal image processing result. Instead, in an embodiment, the parameters are fine-tuned or adjusted in the backpropagation step.

One way of creating the image chain includes replacing each image processing function by its neural network equivalent, as explained above. This may include the advantage of requiring less effort in choosing parameters for the image chain method blocks. However, the image chain may be optimized even further by making use of a property of neural networks, e.g. that a cascade or chain of many neural networks may be “collapsed” to provide a much shorter chain that approximates the behavior of the original chain. In an embodiment, the method of creating an image chain includes a step of re-arranging the order of image processing functions to obtain an image chain approximation. This results in even fewer parameters and fewer computation steps to arrive at comparable results. In an embodiment, the image chain approximation includes at most a single instance of each neural network of the set of neural networks originally identified for the image chain.

As explained above, an initial parameter set may be identified for the image chain. The initial parameter set may be adjusted after performing image processing on one or more test images, for example by comparing a result with an expected or desired result and adjusting the parameter set accordingly. In an embodiment, a calibration step may be carried out before using the image chain in actual real-life imaging procedures. In the calibration step, an image (for example any image previously obtained by that imaging system or a comparable imaging system) is passed through the image chain multiple times, using a different parameter set each time, to obtain a plurality of image processing results. The plurality of image processing results may be shown to a user, who may then select the best image (the user is effectively taking on the role of “loss function”). Subsequently, backpropagation is performed on the basis of the selected, e.g. optimally processed image to identify an optimal set of parameters for the image chain. A calibration sequence might involve N first passes using N variants of a “rough” set of parameters, and the process may be repeated for successive adjustments of the parameter set. For example, a calibration sequence may include four first passes using four variants of a “rough” set of parameters. Of the four candidate result images, the user selects the best one, and the parameter set is adjusted accordingly. In a subsequent step, four second passes are made, using four variants of that updated parameter set. This may be repeated a number of times, resulting in convergence to an optimal parameter set. An advantage of this calibration step is that the step is simple and intuitive from the user's point of view. The user may easily identify which image is “best” without having to understand the significance of the parameters actually being used by the image chain.

### BRIEF DESCRIPTION OF THE FIGURES

FIG. 1 depicts an operation set of the image chain, including a plurality of neural networks according to an embodiment.

FIG. 2 depicts an image chain created by an embodiment of the method.

FIG. 3 depicts results generated using the image chain according to an embodiment.

FIG. 4 depicts an image chain approximation according to an embodiment.

FIG. 5 depicts an embodiment of the imaging system.

FIG. 6 depicts an embodiment of the imaging system.

FIG. 7 depicts a prior art image chain.

FIG. 8 depicts a prior art imaging system.

### DETAILED DESCRIPTION

In the figures, like numbers refer to like objects throughout. Objects in the diagrams are not necessarily drawn to scale.

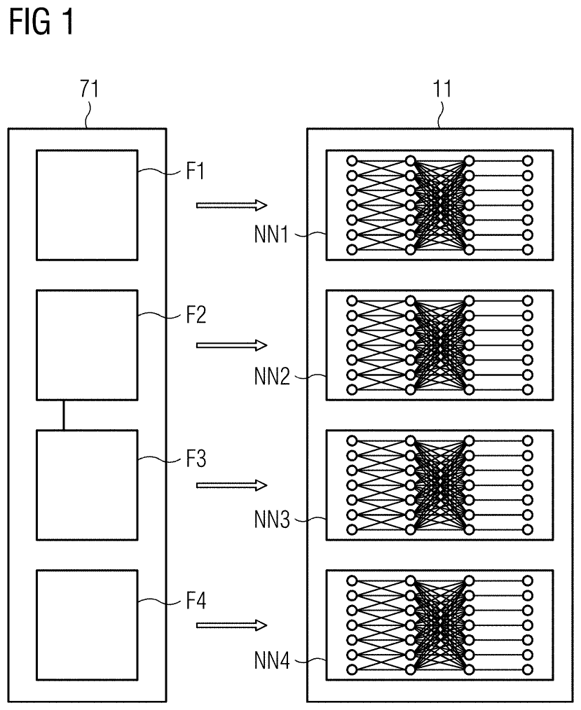

FIG. 1 depicts an operation set 11 including a plurality of neural networks NN1, NN2, NN3, NN4. Each neural network NN1, NN2, NN3, NN4 is configured to perform a task corresponding to an image processing function F1, F2, F3, F4 that will be used in a block of an image chain. The intended image chain will be used to the same purpose as a conventional image chain that implements that set 71 of image processing functions F1, F2, F3, F4. Although the diagram indicates only four functions F1, F2, F3, F4 and their corresponding neural networks NN1, NN2, NN3, NN4, there is no limit to the number of functions implemented by an image chain.

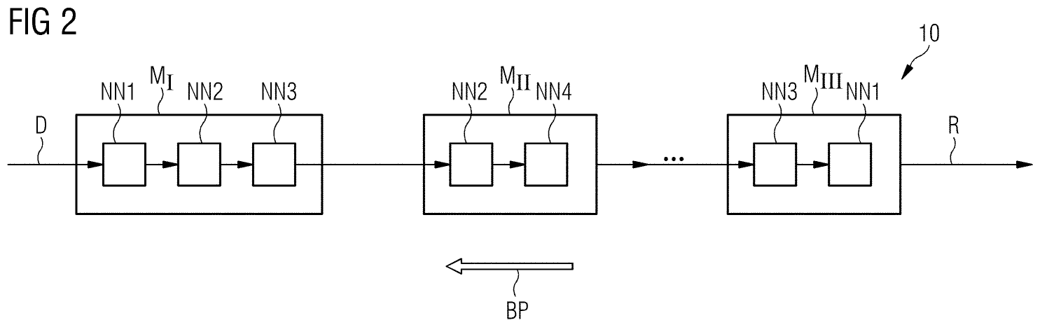

FIG. 2 depicts an image chain 10 as created by an embodiment. The input to the chain 10 may be raw 2D image data D obtained from an imaging device such as an X-ray device, for example. The output of the chain 10 is a processed image R that may be presented to a user. For example, a radiologist or doctor may examine the result R for diagnostic purposes. In the image chain 10, only three method blocks M_{I}, M_{II}, M_{III} are shown, but an image chain may include any number of method blocks. The first method block M_{I} of the image chain 10 implements three neural networks NN1, NN2, NN3 to perform the functions of three corresponding image processing methods F1, F2, F3. For example, the first method block M_{I} may process a 2D X-ray image D by performing Laplace decomposition, then shrinkage, and finally re-composition. The output of the first method block M_{I} is then passed to the second method block M_{II}. The second method block M_{II} of the image chain 10 implements two neural networks NN2, NN4 to perform the functions of two corresponding image processing methods. For example, the second method block M_{II} may process the output of the first method block M_{I} by performing bilateral filtering followed by median filtering. The output of the second method block M_{II} is then passed to the third method block M_{III}. The third method block M_{III} of the image chain 10 also implements two neural networks, in this case neural networks NN3, NN1 to perform the functions of the corresponding image processing methods. For example, the third method block M_{III} may process the output of the second method block M_{II} by Laplace denoising. The image chain 10 terminates at the output of the third method block M3.

After completion of the image chain 10, input parameters to the method blocks M_{I}, M_{II}, M_{III} are adjusted by applying a back-propagation algorithm as indicated by the arrow BP.

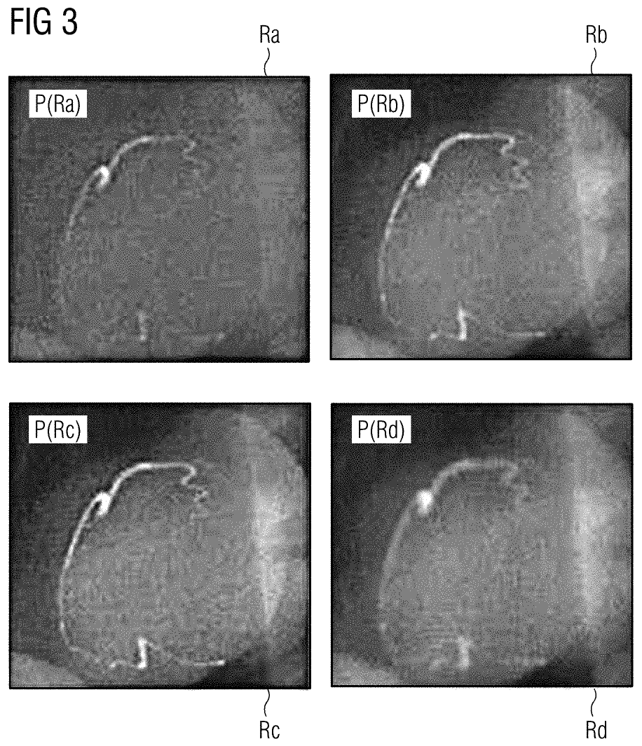

As explained above, an initial training step may be performed by a user to optimize the results. Initial parameters Pᵢₙᵢₜᵢₐₗ for an image chain 10 may have been set automatically or may have been set by the user. FIG. 3 depicts four “test results” Ra, Rb, Rc, Rd that may be generated using the image chain 10 of FIG. 2 and presented to the user for appraisal. Each result Ra, Rb, Rc, Rd may have been generated using one of four different parameter sets P(Ra), P(Rb), P(Rc), P(Rd). The user—acting as “loss function”—may select the best candidate. In this example, the best candidate may be the image at the bottom left, since this image Rc shows sharper contours and more detail than the other three images. The user may select this image Rc, so that the corresponding set of input parameters P(Rc) is considered to be the optimal parameter set and will be used in future for all equivalent image processing procedures.

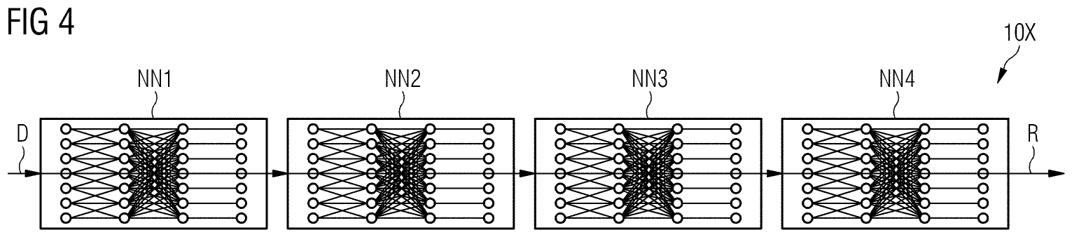

The image chain 10 of FIG. 2 uses various instances of four different neural networks. Each of the neural networks NN1, NN2, NN3 are used twice, for example, the image chain 10 uses two instances of each of these neural networks NN1, NN2, NN3. In a further embodiment, the image chain 10 of FIG. 2 may be optimized by “collapsing” the various steps into a shorter chain by removing redundant steps that occur multiple times in the pipeline. In the embodiment depicted in FIG. 4, the image chain 10 of FIG. 2 has been optimized to include a sequence of only four stages, for example, a sequence in which each neural network NN1, NN2, NN3, NN4 is only implemented once. The single instance of a neural network in the image chain 10X makes essentially the same contribution as the two instances of that neural network in the image chain 10 of FIG. 2, so that the end result of this image chain 10X will be an approximation of the end result of the image chain 10 of FIG. 2. However, the advantage of this approach is that it is faster and uses fewer resources.

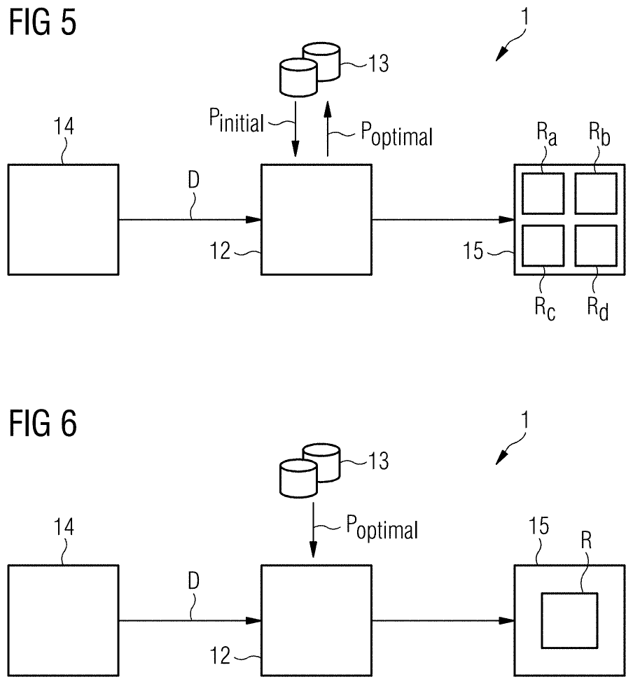

FIG. 5 and FIG. 6 illustrate the implementation of the method and depict a block diagram of an embodiment of the imaging system 1. The developer or provider of the imaging pre-processor establishes a suitable initial parameter set Pᵢₙᵢₜᵢₐₗ that may be delivered to all customers. As illustrated in FIG. 5, the customer may initiate a calibration step by generating an image using an imaging device 14 or supplying a suitable test image. The image data D is input to a processing unit 12 that is configured to carry out the steps of the method using an image chain 10, 10X as explained above, using variants of the initial parameter set Pᵢₙᵢₜᵢₐₗ. Results Ra, Rb, Rc, Rd of the image pre-processing are presented to the user on a suitable display unit 15 such as a monitor. The user chooses the best result from the selection of results Ra, Rb, Rc, Rd. Based on the user's choice, the imaging system 1 identifies the set of parameters Pₒₚₜᵢₘₐₗ that will be used in future for the image chain 10, 10X as indicated in FIG. 6. The set of parameters Pₒₚₜᵢₘₐₗ may be stored in any suitable memory module 13. Any imaging procedure that is carried out using the optimal set of parameters Pₒₚₜᵢₘₐₗ for the image chain 10, 10X will deliver optimal results R to the user.

FIGS. 5 and 6 depict hardware such as the imaging device 14 and the display unit 15 to be part of the overall imaging system 1, but the method may be executed on an existing imaging system 1 by providing a computer-readable medium on which is stored program elements that may be read and executed by a computer unit to perform the image pre-processing method when the program elements are executed by the computer unit.

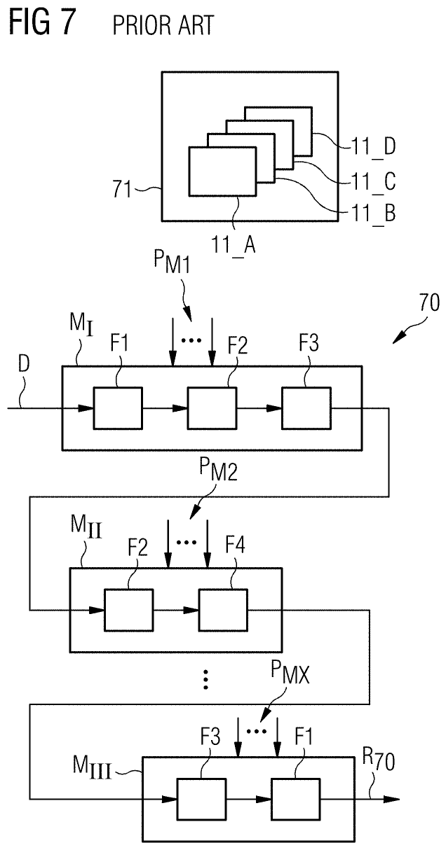

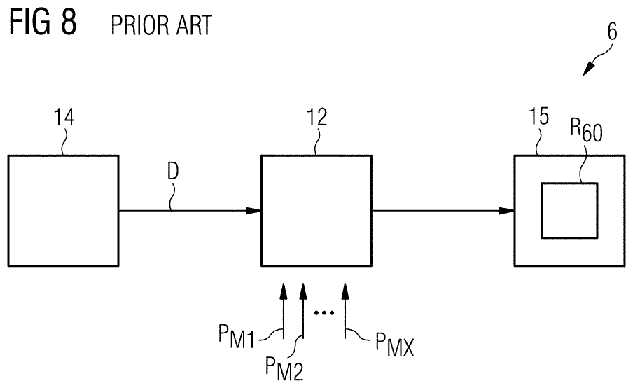

FIG. 7 depicts an image chain 70 as implemented in the prior art. The image chain 70 is analogous to the image chain of FIG. 2 and includes three method blocks M_{I}, M_{II}, M_{III}. Each method block M_{I}, M_{II}, M_{III} is configured to perform a sequence of operations F1, F2, F3, F4 of an operation set 71 indicated in the upper part of the diagram. The first method block M_{I} of the image chain 70 implements three image processing functions F1, F2, F3 to process a 2D X-ray image, for example to perform Laplace decomposition, then shrinkage, and finally re-composition. The output of the first method block M_{I} is then passed to the second method block M_{II}. The second method block M_{II} of the image chain 70 implements two image processing functions F1, F4, for example to carry out various filtering steps. The output of the second method block M_{II} is then passed to the third method block M_{III}. The third method block M_{III} of the image chain 70 implements two image processing functions F3, F1 to complete the processing. The image chain 70 terminates at the output of the third method block M_{III}. For the image chain 70 to function correctly, it is necessary to choose specific parameter sets P_{M1}, P_{M2}, P_{M3} for the various stages of the image chain 70. Each parameter set P_{M1}, P_{M2}, P_{M3} that is input to a method block M_{I}, M_{II}, M_{III} may include many individual parameters. As explained above, it is not easy to correctly choose suitable parameter values for the operations F1, F2, F3, F4 of a method block M_{I}, M_{II}, M_{III}, and it may be impossible to predict how the parameters chosen for one method block may affect the performance of a method block further downstream in the image chain 70. Furthermore, different customers of an image processing system may have very different requirements, that makes it even more difficult for a provider to deliver a system that will function equally well for all customers. The user of a system that implements a prior art image chain may have to deal with the issue of identifying and choosing suitable parameters P_{M1}, P_{M2}, P_{M3}. Because it is difficult to choose suitable parameters for the prior art image chain 70, the quality of the resulting image R₇₀ may be less than optimal.

FIG. 7 shows a very simple block diagram of a prior art imaging system 7. The imaging system 7 includes an imaging device 14, a processing unit 12, and a display unit 15. Suitable parameters P_{M1}, P_{M2}, P_{M3} are input to the processing unit 12, by the provider and/or by the user. The outcome of the prior art image chain is shown in the display unit 15.

Although the present invention has been disclosed in the form of preferred embodiments and variations thereon, it will be understood that numerous additional modifications and variations could be made thereto without departing from the scope. For example, although the method has been described in the context of processing 2D X-ray images, the method may equally be applied to the processing of 3D, 2D-plus-time and also 3D-plus-time images. It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method of creating an image chain, the method comprising:
identifying image processing functions for the image chain;
replacing each of the identified image processing functions by a corresponding neural network;
determining a sequence of execution of instances of the neural networks for the image chain; and
applying backpropagation through the neural networks of the image chain.

2. The method of claim 1, wherein identifying the image processing functions comprises:
identifying method blocks of the image chain; and
identifying any of the image processing functions implemented in each method block of the image chain.

3. The method of claim 1, wherein an image processing function of the image processing functions comprises a linear operation configured to carry out a Gauss filter operation, a Vesselness filter operation, a wavelet shrinkage operation, or any combination thereof.

4. The method of claim 1, wherein an image processing function of the image processing functions comprises a non-linear operation configured to carry out an erosion filter operation, a dilatation filter operation, a median filter operation, or any combination thereof.

5. The method of claim 1, further comprising:
obtaining a neural network for a non-linear operation, the obtaining of the neural network for the non-linear operation comprising applying a universal approximation theorem.

6. The method of claim 1, further comprising:
identifying an initial parameter set for the neural networks of the image chain.

7. The method of claim 1, wherein parameters of the neural networks of the image chain are adjusted during the backpropagation.

8. The method of claim 1, further comprising:
obtaining an image chain approximation, the obtaining of the image chain approximation comprising rearranging an order of the image processing functions to obtain an image chain approximation.

9. The method of claim 8, wherein the image chain approximation comprises at most a single instance of each of the neural networks.

10. The method of claim 1, further comprising:
generating an image processing result, the generating of the image processing result comprising passing an image through the image chain.

11. The method of claim 10, further comprising obtaining a plurality of image processing results, the plurality of image processing results comprising the image processing result,
wherein the obtaining of the plurality of image processing results comprises passing the image through the image chain multiple times, and
wherein applying backpropagation is performed based on an optimally processed image.

12. The method of claim 11, further comprising depicting the plurality of image processing results to a user,
wherein the optimally processed image is identified by the user.

13. An imaging system comprising:
an input configured to obtain an image generated by an imaging device;
a processor configured to:
create an image chain, the creation of the image chain comprising:
identification of image processing functions for the image chain;
replacement of each of the image processing function by a corresponding neural network;
determination of a sequence of execution of instances of the neural networks for the image chain; and
application of backpropagation through the neural networks of the image chain; and
pass the image through the image chain, such that an image processing result is obtained; and
a display unit configured to present the image processing results to a user.

14. The imaging system of claim 13, wherein the imaging device comprises an X-ray imaging device.

15. A non-transitory computer implemented storage medium that stores machine-readable instructions executable by at least one processor to create an image chain, the machine-readable instructions comprising:
identifying image processing functions for the image chain;
replacing each of the identified image processing functions by a corresponding neural network;
determining a sequence of execution of instances of the neural networks for the image chain; and
applying backpropagation through the neural networks of the image chain.

16. The non-transitory computer implemented storage medium of claim 15, wherein identifying the image processing functions comprises:
identifying method blocks of the image chain; and
identifying any of the image processing functions implemented in each method block of the image chain.

17. The non-transitory computer implemented storage medium of claim 15, wherein an image processing function of the image processing functions comprises a linear operation configured to carry out a Gauss filter operation, a Vesselness filter operation, a wavelet shrinkage operation, or any combination thereof.

18. The non-transitory computer implemented storage medium of claim 15, wherein an image processing function of the image processing functions comprises a non-linear operation configured to carry out an erosion filter operation, a dilatation filter operation, a median filter operation, or any combination thereof.
